(19) United States
(12) Patent Application Publication
(10) Pub. No.: US 2012/0099028 A1
(43) Pub. Date: Apr. 26, 2012

(54) LIGHTING DEVICE, DISPLAY DEVICE AND TELEVISION RECEIVER

(75) Inventor: Masashi Yokota, Osaka-shi (JP)

(73) Assignee: SHARP KABUSHIKI KAISHA, Osaka-shi, Osaka (JP)

(21) Appl. No.: 13/376,217

(22) PCT Filed: Apr. 6, 2010
(86) PCT No.: PCT/JP2010/056224

§ 371 Date: Dec. 5, 2011

(30) Foreign Application Priority Data
Jun. 15, 2009 (JP) 2009-142057

(51) Int. Cl. H04N 3/12; G02F 1/13357; G09F 13/04; F21V 21/00; F21V 5/04

(52) U.S. Cl. 348/798; 362/249.01; 362/249.02; 362/235; 362/97.1; 349/61; 348/E03.012

(57) ABSTRACT

It is an object of the present invention to provide a lighting device configured to partially adjust illumination brightness at low cost. A lighting device 12 of the present invention comprises a plurality of light source boards 20, and a plurality of point light sources 17 mounted on each of the light source boards 20. The light source boards 20 are arranged parallel to one another at small intervals in a small-interval area 20a and large intervals in a large-interval area 20b.

### TECHNICAL FIELD

The present invention relates to a lighting device, a display device and a television receiver.

### BACKGROUND ART

For example, a liquid crystal panel used for a liquid crystal display device such as a liquid crystal television does not emit light, and thus a backlight unit is required as a separate lighting device. The backlight unit is known, which is placed behind the liquid crystal panel (on a side opposite to a display surface side). The backlight unit includes numerous light sources (for example, LEDs).

An almost uniform illumination brightness distribution is required for the backlight unit. However, because human eyes usually pay attention to a center of a screen of the liquid crystal display device, a configuration is known, which brightens up a center of a screen and slightly darkens an end part of the screen to make visual uneven brightness less noticeable (the following Patent Document 1). In the device disclosed in Patent document 1, a distribution density of LEDs in a place requiring high brightness on an LED substrate is higher than a distribution of density in the other place, and thereby brightness in the place requiring high brightness is adjusted so as to be different from that in the place not requiring high brightness. Alternatively, a configuration in which a height of each LED is changed, or a configuration in which an impressed current value to each LED is changed is disclosed as adjusting means for varying brightness.
Patent Document 1: Japanese Unexamined Patent Publication No. 2007-317423

### Problem to be Solved by the Invention

The device disclosed in Patent Document 1 has a configuration in which a physical arrangement of the LEDs is changed on the LED substrate. For example, the distribution density of the LEDs is great in a center part of the LED substrate, and the distribution density of the LEDs is slightly decreased toward an end part of the LED substrate. Thereby, it is necessary to change a length of the LED substrate and an arranging mode of the LEDs on the LED substrate, for each size of the lighting device. Therefore, when a plurality of lighting devices having different sizes is manufactured, the number of the LED substrates which should be prepared is accordingly increased. Increase in the number of the LED substrates may cause complicated management and cost increase. When the impressed current value to each LED is changed, it is necessary to provide a control unit for each LED, which causes inevitable cost increase.

### Disclosure of the Present Invention

The present invention was accomplished in view of the above circumstances. It is an object of the present invention to provide a lighting device configured to partially adjust illumination brightness at low cost. It is another object of the present invention to provide a display device comprising the lighting device. It is still another object of the present invention to provide a television receiver comprising the display device.

### Means for Solving the Problem

To solve the above problem, a lighting device of the present invention comprises a plurality of light source boards, and a plurality of point light sources mounted on each light source board. The light source boards are arranged parallel to one another at large intervals in a large-interval area and at small intervals in a small-interval area.

In this case, small-interval area is provided in a portion in which high brightness is required, and the large-interval area is provided in a portion in which high brightness is not necessarily required. Thereby, illumination brightness can be partially adjusted. Because brightness can be adjusted by arranging intervals between the light source boards without changing an arrangement of the point light sources on each light source board, the light source boards can be repeatedly used even if a size of the lighting device is changed. Therefore, cost reduction can be achieved.

### BRIEF DESCRIPTION OF THE DRAWINGS

FIG. 1 is an exploded perspective view illustrating a schematic configuration of a television receiver according to an embodiment of the present invention;

FIG. 2 is an exploded perspective view illustrating a schematic configuration of a liquid crystal display device included in the television receiver;

FIG. 3 is a cross-sectional view illustrating a cross-sectional configuration along a long-side direction of the liquid crystal display device;

FIG. 4 is a cross-sectional view illustrating a cross-sectional configuration along a short-side direction of the liquid crystal display device;

FIG. 5 is an enlarged sectional view of an essential part illustrating a configuration of a member attached to an LED substrate;

FIG. 6 is an enlarged sectional view of an essential part illustrating a configuration of a member attached to an LED substrate;

FIG. 7 is a plan view illustrating an arranging mode of LED substrates in a chassis; and

FIG. 8 is a plan view illustrating a modification of an arranging mode of LED substrates in a chassis.

### BEST MODE FOR CARRYING OUT THE INVENTION

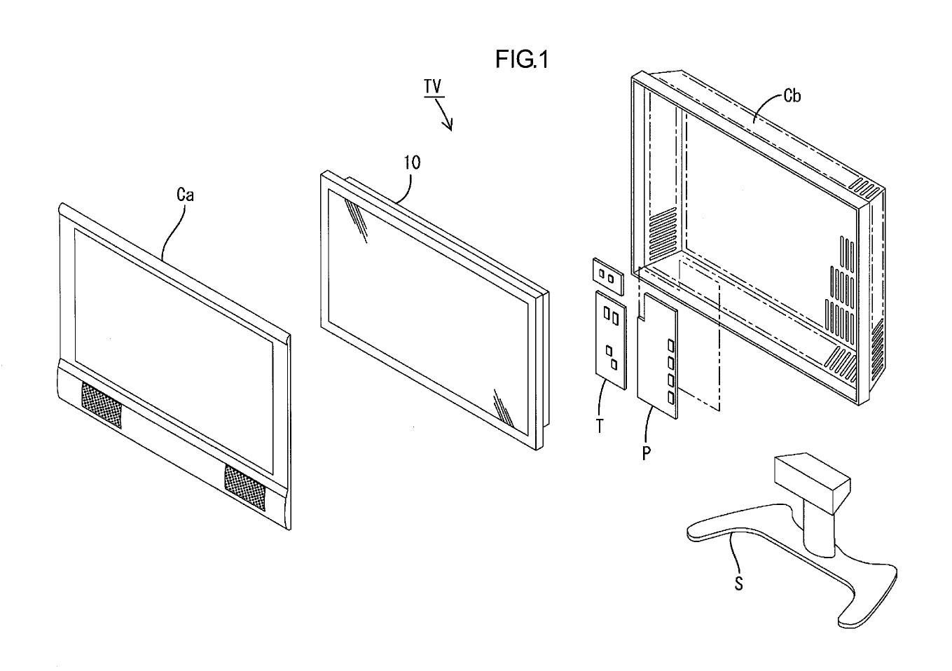

An embodiment of the present invention will be described with reference to FIGS. 1 to 7.

First, a configuration of a television receiver TV comprising a liquid crystal display device 10 will be described.

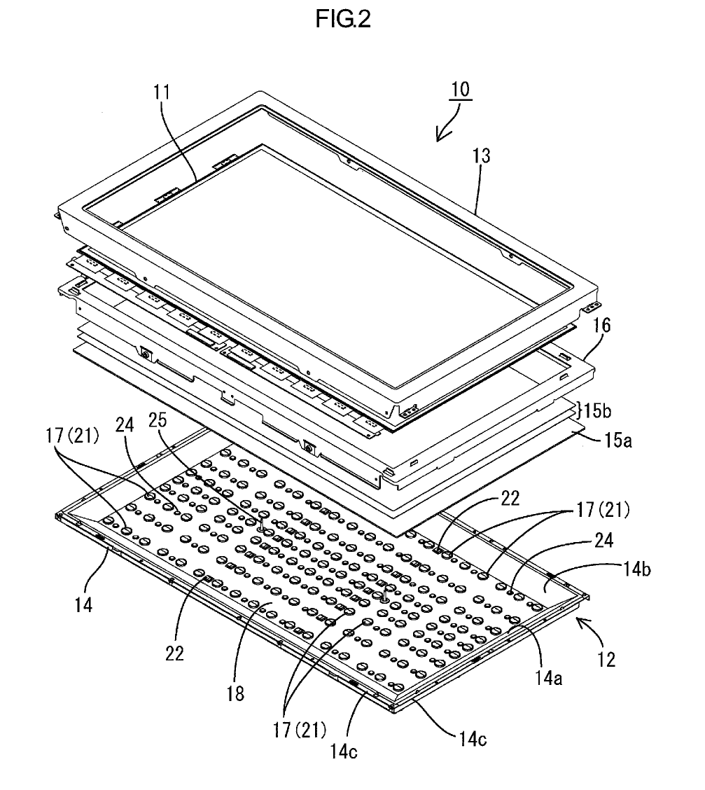

As illustrated in FIG. 1, the television receiver TV of the present embodiment comprises the liquid crystal display device 10, front and rear cabinets Ca, Cb which house the liquid crystal display device 10 therebetween, a power source P, a tuner T and a stand S. An entire shape of the liquid crystal display device (display device) 10 is a landscape rectangular. The liquid crystal display device 10 is housed in a vertical position. As illustrated in FIG. 2, the liquid crystal display device 10 comprises a liquid crystal panel 11 as a display panel, and a backlight device (lighting device) 12 as an external light source. The liquid crystal panel 11 and the backlight device 12 are integrally held by a frame shaped bezel 13 and the like.

Next, the liquid crystal panel 11 and the backlight device 12 included in the liquid crystal display device 10 will be described (see FIGS. 2 to 4).

The liquid crystal panel (display panel) 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. Polarizing plates are attached to outer surfaces of the substrates.

As illustrated in FIG. 2, the backlight device 12 comprises a chassis 14, an optical sheet set 15 (a diffuser 15a, and a plurality of optical sheets 15b which is provided between the diffuser 15a and the liquid crystal panel 11), and a frame 16. The chassis 14 has a substantially box-shape, and opens to the light output side (on the liquid crystal panel 11 side). The optical sheet set 15 is provided so as to cover the opening of the chassis 14. The frame 16 provided along an outer edge of the chassis 14 holds an outer edge part of the diffuser 15a in a state where the outer edge part is sandwiched between the frame 16 and the chassis 14. Furthermore, light-emitting diodes 17 (point light sources, hereinafter, referred to as LEDs) are arranged in the chassis 14. In the backlight unit 12, a light output side of the backlight unit 12 is a side closer to the diffuser 15a than the LEDs 17.

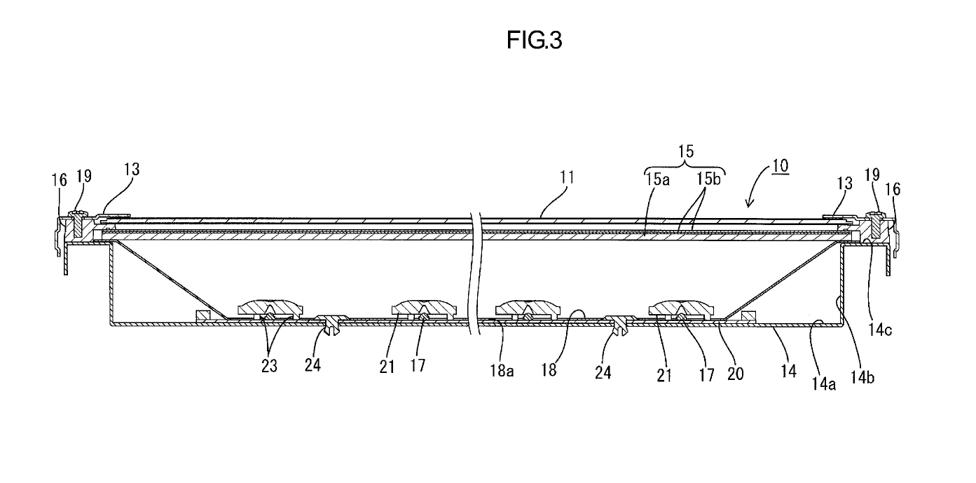

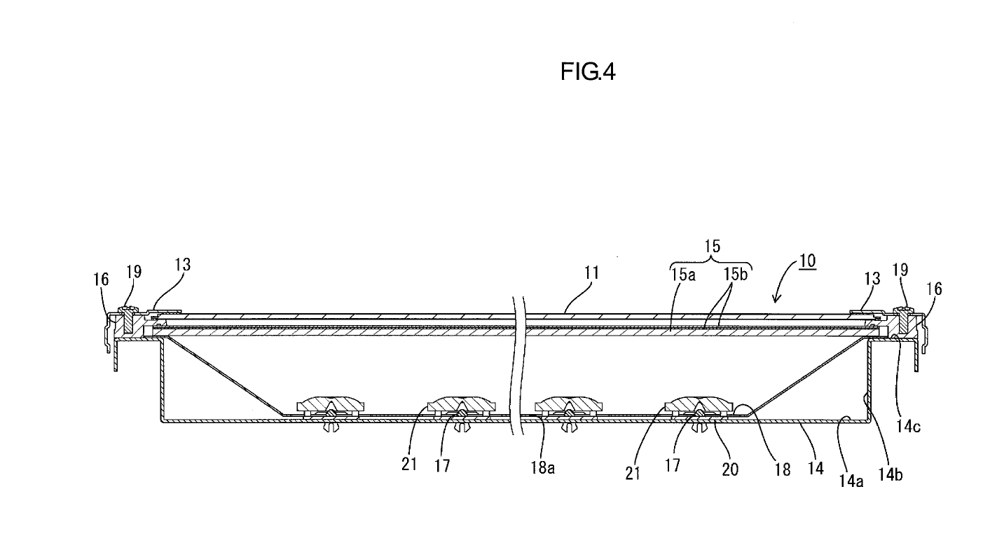

The chassis 14 is made of metal. The chassis 14 includes a rectangular bottom plate 14a like the liquid crystal panel 11, side plates 14b each of which rises from an outer edge of the corresponding side of the bottom plate 14a, and a receiving plate 14c outwardly overhanging from a rising edge of each of the side plates 14b. An entire shape of the chassis 14 is a substantially shallow box shape opened to the front side. As illustrated in FIGS. 3 and 4, the frame 16 is placed on the receiving plate 14c of the chassis 14. Outer edge parts of a reflection sheet 18 and optical sheet set 15 to be described later are sandwiched between the receiving plate 14c and the frame 16. Furthermore, mounting holes 16a are bored in an upper surface of the frame 16 to bind the bezel 13, the frame 16 and the chassis 14 and the like together with screws 19 and the like.

The optical sheet set 15 including the diffuser 15a and the optical sheets 15b is provided on the opening side of the chassis 14. The diffuser 15a includes a plate-like member made of a synthetic resin and light scattering particles dispersed in the plate-like member. The diffuser 15a has a function for diffusing point light emitted from the LEDs 17 as the point light sources. The outer edge portion of the diffuser 15a is placed on the receiving plate 14c of the chassis 14 as described above, and does not receive a vertical strong restricting force.

The optical sheets 15b provided on the diffuser 15a have a sheet shape and a plate thickness thinner than that of the diffuser 15a, and the two sheets are laminated. Specific examples of the optical sheets 15b include a diffuser sheet, a lens sheet and a reflecting type polarizing sheet. These sheets can be suitably selected to be used. Light emitted from the LEDs 17 passes through the diffuser plate 15a. The optical sheets 15b have a function for converting the light to planar light. The liquid crystal panel 11 is placed on the upper surface side of the optical sheets 15b.

The reflection sheet 18 is provided on the bottom plate 14a and inner surfaces of the side plates 14b of the chassis 14 to cover the almost entire chassis 14. The reflection sheet 18 is made of a synthetic resin, and has a surface having white color that provides excellent light reflectivity. The reflection sheet 18 has a hole part 18a formed at a position corresponding to a diffuser lens 21 to be described later therein. Therefore, although the entire bottom plate 14a of the chassis 14 is covered with the reflection sheet 18, the diffuser lens 21 is exposed to the optical sheet set 15 side through the hole portion 18a. The reflection sheet 18 obliquely rising from the edge part of the bottom plate 14a covers the inner surfaces of the side plates 14b. The outer edge part thereof is placed on the receiving plate 14c of the chassis 14. The light emitted from the LEDs 17 can be reflected to the diffuser 15a side by the reflection sheet 18.

Furthermore, an LED substrate (light source board) 20 is placed on the inner surface of the bottom plate 14a of the chassis 14. The LEDs 17 and the diffuser lenses 21 are attached to the LED substrate 20. The LED substrate 20 is made of a synthetic resin. The LED substrate 20 has a surface on which a wiring pattern (not shown) including a metal film such as a copper foil is formed. The LEDs 17 are obtained by combining a blue diode chip emitting blue single color light with a fluorescent material, and emit white color light. The LEDs 17 are electrically connected in series by the wiring pattern formed on the LED substrate 20.

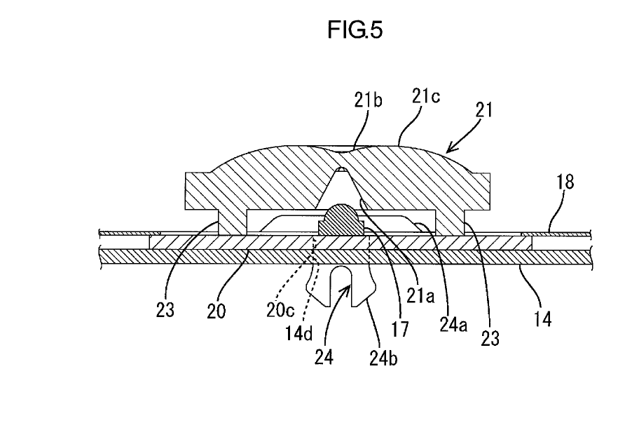

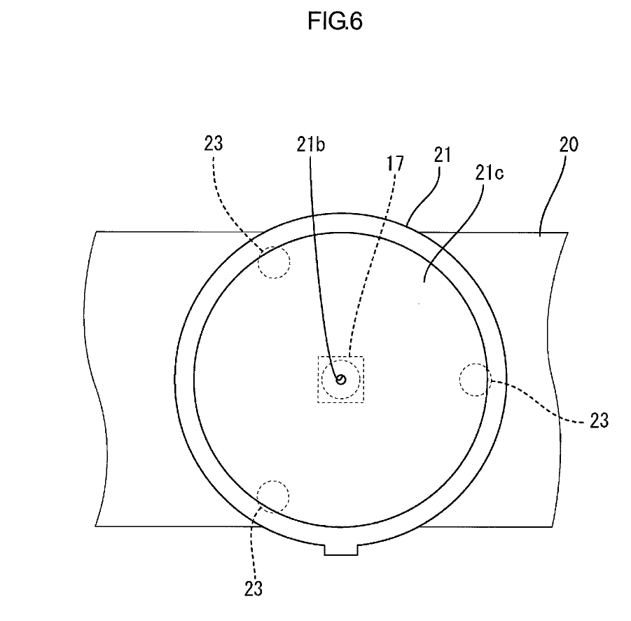

The diffuser lens 21 is made of a synthetic resin such as acrylic having high light transmission. As illustrated in FIG. 5, the diffuser lens 21 has a semispherical shape, and covers each of the LEDs 17. Three leg parts 23 are provided so as to protrude from a peripheral part of a lower surface of the diffuser lens 21. As illustrated in FIG. 6, the three leg parts 23 are arranged at approximately equal intervals (intervals of about 120 degrees) along a peripheral part of the diffuser lens 21. For example, the leg parts 23 are fixed to the surface of the LED substrate 20 by an adhesive or a thermosetting resin. The diffuser lens 21 has an incident concave part 21a at the portion overlapping with the LED 17 in the lower surface of the diffuser lens 21 (the surface opposite to the LED 17) in a plan view. The incident concave part 21a has a substantially conical shape in a manner recessed to the upper side. Light from the LED 17 is made incident on the incident concave part 21a. On the other hand, the diffuser lens 21 has a concave part 21b at the upper surface thereof (a surface opposite to the diffuser 15a). The concave part 21b is recessed to the lower side in a center part (a portion overlapping with the LED 17 in a plan view). Thereby a light output surface 21c having a shape obtained by connecting two gentle circular arcs is formed. The light emitted from the LED 17 is refracted between an air layer and the incident concave part 21a and between the light output surface 21c and the air layer, and thereby the light is diffused in a planar shape. The diffused light is radiated to the diffuser 15a side from the concave part 21b and the light output surface 21c over a wide angle range.

As illustrated in FIG. 5, the LED substrate 20 is fixed to the bottom plate 14a of the chassis 14 by a rivet 24. The rivet 24 has a disc-shaped holding part 24a and a locking part 24b protruding to the lower side from the holding part 24a. An insertion hole 20c into which the locking part 24b is inserted is bored in the LED substrate 20. A mounting hole 14d communicated with the insertion hole 20c is bored in the bottom plate 14a of the chassis 14. A tip part of the locking part 24b of the rivet 24 is an elastically deformable wide part. After the tip part is inserted into the insertion hole 20c and the mounting hole 14d, the tip part can be locked with a back surface side of the bottom plate 14a of the chassis 14. Thereby, the rivet 24 can fix the LED substrate 20 to the bottom plate 14a with the holding part 24a holding the LED substrate 20.

As illustrated in FIG. 2, a support pin 25 is provided so as to protrude from a surface of the rivet 24 located near a center part of the bottom plate 14a of the chassis 14. The support pin 25 has a tapered conical shape. When the diffuser 15a is distorted to the lower side, the diffuser 15a and a tip of the support pin 25 are brought into point contact with each other, and thereby the diffuser 15a can be supported from the lower side. The support pin 25 has also a function for easily handling the rivet 24 when the support pin 25 is grasped.

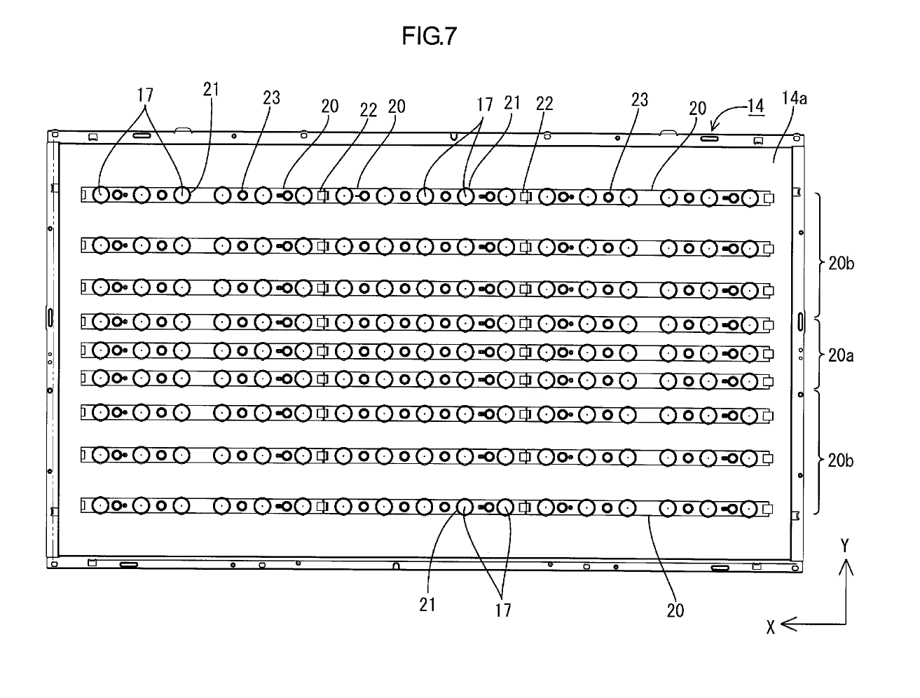

Then, the arranging mode of the LED substrates 20 will be described using FIG. 7. FIG. 7 is a plan view illustrating the arranging mode of the LED substrates in the chassis.

Each LED substrate 20 is a plate-like member having an elongated shape as illustrated in FIG. 7. Five or six LEDs 17 are arranged on a straight line (on a line) along a longitudinal direction of the LED substrate 20. More particularly, the five or six LEDs 17 are surface-mounted at equal intervals on each LED substrate 20.

The LED substrates 20 are arranged with a longitudinal direction thereof aligned with a long-side direction (X-axial direction) of the chassis 14. More particularly, three LED substrates 20, 20, 20 are arranged along the long-side direction of the chassis 14 with the longitudinal directions thereof being aligned, and are electrically and physically connected to each other by the connectors 22.

Furthermore, when the LED substrates 20 are viewed in a short-side direction (Y-axial direction) of the chassis 14, nine rows of the three LED substrates 20, 20, 20 connected in series are arranged parallel to one another. These LED substrates 20 have a small-interval area 20a where an interval thereof is relatively small in a center part (that is, a center part of the bottom plate 14a of the chassis 14). These LED substrates 20 also have a large-interval area 20b where an interval is relatively large in an end part (that is, an end part of the bottom plate 14a). More specifically, the interval of the LED substrates 20 in the small-interval area 20a is the smallest, and the interval of the LED substrates 20 in the large-interval area 20b is gradually increased toward the direction away from the small-interval area 20a, in other words, from the center part in the short-side direction of the bottom plate 14a toward both the end parts thereof. These LED substrates 20 have an external control unit (not illustrated) connected thereto. Power required for lighting on of the LEDs 17 is supplied from the control unit, and thereby the LEDs 17 can be driven and controlled.

The above embodiment realizes the following operations and effects.

First, the LED substrates 20 on which the LEDs 17 are mounted are arranged parallel to one another such that the small-interval area 20a where the interval thereof is relatively small and the large-interval area 20b where the interval is relatively large are provided.

In this case, the small-interval area 20a of the LED substrates 20 is provided in the portion in which high brightness is required, and the large-interval area 20b of the LED substrates 20 is provided in the portion in which high brightness is not necessarily required. Thereby, illumination brightness can be partially adjusted. Because brightness can be adjusted by changing the arranging interval between the LED substrates 20 without changing the arrangement of the LEDs 17 on each LED substrate 20, the LED substrates 20 can be repeatedly used even if the size of the backlight unit 12 is changed, thereby cost reduction can be achieved.

In the present embodiment, the small-interval area 20a of the LED substrates 20 is located in the center part of the arrangement of the LED substrates 20, and the large-interval area 20b is located in the end part of the arrangement of the LED substrates 20. According to such a configuration, illumination brightness of the backlight unit 12 can be increased on the center part side of the arrangement to bring about excellent visibility.

The large-interval area 20b has the interval between the LED substrates 20, 20 increased toward the direction away from the small-interval area 20a. According to such a configuration, the number of the LEDs 17 and the number of the LED substrates 20 in the large-interval area 20b can be decreased while the brightness distribution of illumination light is gradually changed, to achieve cost reduction.

The plurality of LEDs 17 is arranged at equal intervals on one of the LED substrate 20. Because the arranging mode of the LEDs 17 is not changed by the LED substrates 20 in this case, the LED substrates 20 can be repeatedly used even if the size of the backlight unit 12 is changed.

Each LED substrate 20 has the elongated shape, and is arranged with the longitudinal direction thereof aligned with the long-side direction of the chassis 14. According to such a configuration, the number of the LED substrates 20 can be decreased as compared with a case where the short-side direction of the chassis 14 and the longitudinal direction of each LED substrate 20 are aligned with each other. Therefore, for example, the number of control units controlling lighting on and off of the LEDs 17 can be decreased, and thereby cost reduction can be realized.

The plurality of LED substrates 20 is arranged along the longitudinal direction thereof, and the adjacent LED substrates 20, 20 are connected by the connector 22.

According to such a configuration, some kinds of LED substrates 20 are prepared, which have different lengths, in other words, in which the number of the arranged LEDs 17 is different, for example. Thereby, this configuration enables the lighting device to correspond to each size by connecting the LED substrates 20, 20 using the connector even when the size of the backlight unit is different. Therefore, the configuration can contribute to cost reduction without requiring the LED substrate 20 for each size of the backlight unit 12.

Because the LEDs 17 are employed as the light sources in the present embodiment, longer life and lower power consumption and the like of the light sources can be achieved.

Because the diffuser lens 21 configured to diffuse light from each LED 17 is attached so as to cover each LED 17, a point lamp image is hardly generated also when the interval between the adjacent LEDs 17, 17 is increased. Therefore, the low cost can be achieved by reducing the arranged LEDs 17, and the almost uniform brightness distribution can be obtained.

As described above, the embodiment of the present invention has been illustrated. However, the present invention is not limited to the above embodiment, and may employ following various modifications, for example. In the following modifications, the same constituent parts and constituent elements as those of the above embodiment are indicated by the same symbols, and will not be described.

### <First Modification>

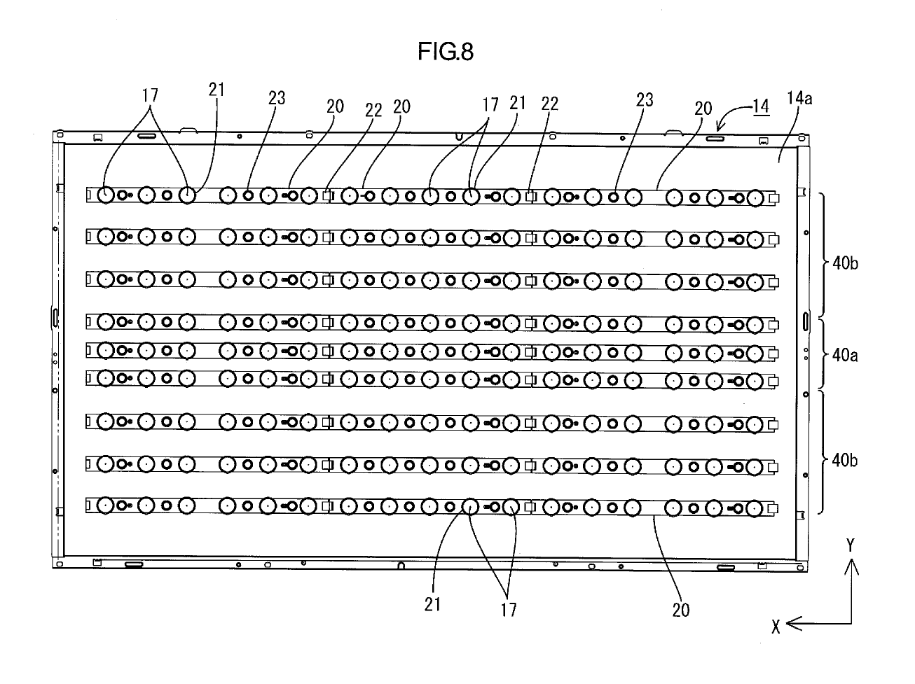

A modification of the arranging mode of the LED substrates 20 is illustrated in FIG. 8, and can be employed. FIG. 8 is a plan view illustrating a modification of the arranging mode of the LED substrates in the chassis.

As illustrated in FIG. 8, the LED substrates 20 are arranged with a longitudinal direction thereof aligned with a long-side direction (X-axial direction) the chassis 14. More particularly, three LED substrates 20, 20, 20 are arranged along the long-side direction of the chassis 14 with the longitudinal directions thereof being aligned, and are electrically and physically connected to each other by the connectors 22.

Furthermore, when the LED substrates 20 are viewed in a short-side direction (Y-axial direction) of the chassis 14, nine rows of the three LED substrates 20, 20, 20 connected in series are arranged parallel to one another. These LED substrates 20 have a small-interval area 40a where an interval thereof is relatively small in a center part (that is, a center part of the bottom plate 14a of the chassis 14). These LED substrates 20 also have a large-interval area 40b where an interval is relatively large in an end part (that is, an end part of the bottom plate 14a). In this context, a distance between the adjacent LED substrates 20, 20 in the small-interval area 40a is uniformed, and a distance between the adjacent LED substrates 20, 20 in the large-interval area 40b is also uniformed.

Thus, even when the LED substrates 20 are arranged such that the small-interval area 40a and the large-interval area 40b are provided, and the distance between the adjacent LED substrates 20, 20 in the large-interval area 40b is controlled to be equal, the almost uniform illumination brightness distribution can be realized over the entire backlight unit 12.

### Other Embodiment

As describe above, the embodiments of the present invention have been described. However, the present invention is not limited to the above embodiments described in the above description and the drawings. The following embodiments are also included in the technical scope of the present invention, for example.

(1) In the above embodiment, the LED substrates have the small-interval area in the center part thereof, and the large-interval area in the end part thereof. However, the small-interval area and the large-interval area are formed in optional positions.

However, because relatively high brightness is required in the center part of the screen of the display device when the backlight unit of the present invention is used for the display device, for example, the small-interval area is suitably located on the inner side of the large-interval area with respect to the parallel direction of the LED substrates.

(2) In the above embodiment, the configuration in which the three LED substrates are connected in the long-side direction (X-axis direction) of the chassis is exemplified. However, the number of the LED substrates may be equal to or less than 2, or equal to or greater than 4. The number of the LEDs arranged on one of the LED substrates is not limited to 5 or 6, and may be optional.

(3) In the above embodiment, the LEDs including the blue diode chip and the fluorescent material are exemplified. However, for example, three kinds of red, green, and blue LED chips may be face-mounted.

(4) In the above embodiment, the LEDs aligned and arranged in the reticular pattern in the longitudinal and lateral directions are exemplified. However, for example, the LEDs may be arranged in a hexagonal closest form, that is, such that all distances between the adjacent LEDs are equivalent, or the LEDs may be alternately arranged.

(5) In the above embodiment, the diffuser lenses arranged so as to cover the LEDs are exemplified. However, the diffuser lenses may not be necessarily arranged. In this case, the occurrence of the point lamp image can be suppressed by densely arranging the LEDs.

(6) In the above embodiment, the LEDs used as the point light sources are exemplified. However, the point light sources other than the LEDs may be used.

(7) In the above embodiment, the optical sheet set obtained by combining the diffuser with the diffuser sheet, the lens sheet, and the reflecting type polarizing sheet is exemplified. However, for example, an optical sheet obtained by laminating two diffusers can also be employed.

1. A lighting device comprising:
a plurality of light source boards; and
a plurality of point light sources mounted on each of the light source boards,
wherein the light source boards are arranged parallel to one another at large intervals in a large-interval area and at small intervals in a small-interval area.

2. The lighting device according to claim 1, wherein the small-interval area is located in a center part of an arrangement of the light source boards, and the large-interval area is located in an end part of the arrangement of the light source boards.

3. The lighting device according to claim 1, wherein the large-interval area has an interval between the light source boards increased toward the direction away from the small-interval area.

4. The lighting device according to claim 1, wherein the plurality of point light sources is arranged at equal intervals on one of the light source boards.

5. The lighting device according to claim 1, further comprising a chassis housing the plurality of light source boards and having a rectangular shape in a plan view, wherein each of the light source boards has an elongated shape and is arranged with a longitudinal direction thereof aligned with a long-side direction of the chassis.

6. The lighting device according to claim 1, wherein:
the light source boards have an elongated shape, and are arranged along a longitudinal direction thereof; and
the adjacent light source boards are connected by a connector.

7. The lighting device according to claim 1, wherein the point light sources are light-emitting diodes.

8. The lighting device according to claim 1, wherein a diffuser lens configured to diffuse light from each of the point light sources is attached so as to cover each of the point light sources.

9. A display device comprising:
the lighting device according to claim 1; and
a display panel configured to provide display using light from the lighting device.

10. The display device according to claim 9, wherein the display panel is a liquid crystal panel using liquid crystals.

11. A television receiver comprising the display device according to claim 9.
